(19) United States
(12) Patent Application Publication
(10) Pub. No.: US 2011/0037355 A1
(43) Pub. Date: Feb. 17, 2011

(54) DRIVE UNIT FOR A VEHICLE SEAT

(75) Inventors: Rolf Schüler, Heilingenhaus (DE); Christoph Schuhn, Dusseldorf (DE)

Correspondence Address: MCGLEW & TUTTLE, PC, P.O. BOX 9227, SCARBOROUGH STATION, SCARBOROUGH, NY, 10510-9227, US

(73) Assignee: Keiper GMBH & Co., KG, Kaiserslautern (DE)

(21) Appl. No.: 12/935,111

(22) PCT Filed: Nov. 3, 2009
(86) PCT No.: PCT/EP09/07850

§ 371 Date: Sep. 28, 2010

(30) Foreign Application Priority Data
Nov. 25, 2008 (DE) 10 2008 059 354.0

(51) Int. Cl. H02K 11/00; H02K 21/12; H01R 39/38; H02K 7/116

(52) U.S. Cl. 310/68 D; 310/156.01; 310/238; 310/83

(57) ABSTRACT

A drive unit (10) for an adjuster in a vehicle, in particular for a vehicle seat, has at least one motor (12) which has a stator (16) with at least one coil (24). At least one rotor (18) which interacts with the stator (16) in a magnetic manner, rotates about an axis (A) and is fitted with permanent magnets. A commutation module (20) is provided for supplying current to the coil (24) as a function of the rotation of the rotor (18). An electrical connection (22) is provided for an at least two-pole supply voltage (+Ub, −Ub). The commutation module (20) is selected from a set of brush-commutating and brushless commutation modules (20), with the structure of the motor (12) otherwise remaining the same.

### CROSS REFERENCE TO RELATED APPLICATIONS

This application is a U.S. National Phase application of International Application PCT/EP2009/007850 and claims the benefit of priority under 35 U.S.C. §119 of German Patent Application DE 10 2008 059 354.0 filed Nov. 25, 2008, the entire contents of which are incorporated herein by reference.

### FIELD OF THE INVENTION

The invention relates to a drive unit for an adjuster in a vehicle, in particular for a vehicle seat, having at least one motor which has a stator with at least one coil at least one rotor which is fitted with permanent magnets, rotates about an axis and magnetically interacts with the stator and a commutation module for supplying current to the coil as a function of the rotation of the rotor and an electrical connection for an at least two-pole supply voltage,

### BACKGROUND OF THE INVENTION

Drive units of this kind, as disclosed in DE 10 2004 019 471 A1 for example, are used for vehicle seats which can be adjusted by a motor in order to reach an optimum sitting position for the occupant by adjusting individual components relative to one another. In this case, both brush-commutated and electronically commutated motors are known. The rotation speed is reduced and, at the same time, the torque which is output is increased by means of a gear stage.

### SUMMARY OF THE INVENTION

The invention is based on the object of improving a drive unit of the type mentioned in the introduction.

According to the invention, a drive unit is provided having at least one motor which has a stator with at least one coil at least one rotor which is fitted with permanent magnets, rotates about an axis and magnetically interacts with the stator and a commutation module for supplying current to the coil as a function of the rotation of the rotor and an electrical connection for an at least two-pole supply voltage. The commutation module is selected from a set of brush-commutating and brushless commutation modules, with the motor otherwise being of the same design.

Against the background of environmentally friendly use of energy in mobile vehicles, the aspect of efficiency of drive systems, whether the main vehicle drive or auxiliary assemblies as in the case of the present drive units, is increasingly important. In addition to the pure degree of efficiency of the conversion of electrical energy into mechanical energy, the mass of the drive units also naturally plays an increasingly important role in mobile applications. Both aspects clearly make an argument for the use of intelligent, lightweight, efficient brushless motors and the continuous reduction in costs for electronic components which has already lasted for a long time and will certainly continue in the future casts this motor technology in an ever more positive light from an economical point of view.

Even though the extra costs for brushless motors already tend toward zero today, in the case of very convenient, electrically adjustable seats with a memory function etc., moving the control intelligence system from a separate control electronics system into the individual drives actually produces, when considered over all the electrical adjusters—that is to say including the most simple solutions—a cost disadvantage when completely changing over all drives to the modern technology. The major proportion of costs results from the actuation of the motors, that is to say ultimately from the process of temporal and spatial assignment of electrical energy to the motor coils, of the commutation itself. Since the overall design of a drive unit is substantially co-determined by the geometric design of the motor part and brush-commutated motors are usually designed in an inverse manner in relation to brushless motors, a solution is required for the design of a construction kit, which can be scaled in terms of cost and performance, for new drives, said solution allowing for different cost and performance requirements given the same basic design of the drive units.

The modular commutation concept resolves the described conflict and therefore provides a technical solution for step-wise, staggered introduction of the microprocessor-based, intelligent, brushless motor technology.

In accordance with the intention to provide a modular overall drive system despite different cost and performance characteristics, essential features and embodiments of the drive units, down to the component level, should be identical to one another and therefore always be reusable. Irrespective of the commutation, the rotor is fitted with at least one permanent magnet, and the commutation module supplies current to at least one coil of the stator.

The drive unit according to the invention preferably drives an adjuster in a vehicle seat. In this case, the drive unit is preferably integrated in a load-bearing gear. The adjuster designed in this way has the advantage that separate transmission elements between the drive unit and the load-bearing gear, for example worm gears or the like which have a poor degree of efficiency, and separate bearing elements for the rotor are superfluous. If, in addition, the rotor continues to be mounted without play by means of the gear stage as far as the load-bearing gear, the running noises are significantly reduced.

A preferred adjuster is in the form of a multi-use rotary adjuster, in particular in the form of a geared fitting which has a self-locking eccentric epicyclic gear and a first fitting part and a second fitting part, which fitting parts rotate relative to one another by means of an eccentric which is driven by the drive unit—preferably by means of a driver. The fitting parts can each have an integrally formed collar or an attached sleeve, by means of which collar or sleeve said fitting parts bear the eccentric and/or accommodate at least a part of the drive unit, preferably the entire drive unit including the commutation module. The eccentric, which is preferably mounted on one of the collars or sleeves, is preferably formed by two bent wedge-like segments, between the narrow sides of which a driver segment of the driver is held with play, and a spring which is held between the facing broad sides of the wedge-like segments and pushes these away from one another in the circumferential direction, for play-free positioning.

The invention is explained in greater detail below with reference to various embodiments with modifications. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view through a drive unit according to the invention;

FIG. 2 is an end view of a unit comprising stator and commutation module;

FIG. 3 is a perspective view of the unit from FIG. 2;

FIG. 4 is a perspective view of a unit comprising stator, commutation module and electrical connection;

FIG. 5 is a view of the unit from FIG. 4 from a different perspective;

FIG. 6 is an illustration of the manner of operation of the commutation with a bipolar motor;

FIG. 7 is a basic illustration of the commutation from FIG. 6 with sliding contacts;

FIG. 8 is an exploded illustration of the individual parts of the sliding contact and also an alternative embodiment of a brush holder;

FIG. 9 is an illustration of the manner of operation of the commutation with a unipolar motor;

FIG. 10 is a basic illustration of the commutation from FIG. 9 with sliding contacts;

FIG. 11 is a basic illustration of the commutation with sliding contacts and electronic switches with a bipolar motor;

FIG. 12 is a basic illustration of an electronic, brushless commutation with electronic switches; and

FIG. 13 is a basic illustration of a microprocessor-controlled, brushless commutation with a bipolar motor.

### DESCRIPTION OF THE PREFERRED EMBODIMENTS

Referring to the drawings in particular, a drive unit 10 has a motor 12 and a gear stage 14 which is provided on the output side of the motor 12. The motor 12 has, within a housing 15, a stator 16, a rotor 18 which is mounted in the housing 15 such that it can rotate about an axis A, a commutation module 20 and an electrical connection 22 for a two-pole DC supply voltage. The positive pole of the supply voltage is designated +Ub, and the negative pole of the supply voltage is designated −Ub.

In all embodiments, the motor 12 is designed such that the rotor 18 is fitted with permanent magnets and the stator 16 has coils 24 which can be alternately supplied with current by the commutation module 20. A coil 24 should also be understood to mean a series circuit comprising two coils, as is realized in the present embodiments. The stator 16, in which all coils 24 are preferably combined at exactly one common star point, can be selected from a set of two possible embodiments, specifically a unipolar embodiment (star point is passed through and connected) and a bipolar embodiment (star point is isolated or the star point which is passed through is not connected). The commutation module 20 can be selected from a set of brush-commutating and brushless commutation modules 20 with the design of the motor 12 otherwise remaining the same. The coils 24 are accordingly supplied with current by means of switches in the widest sense, in particular sliding contacts 26, or by means of an electronic commutation. Stator 16, commutation module 20 and preferably electrical connection 22 can be physically combined to form an exciter unit, a large number of variants of said exciter unit accordingly existing on account of the two embodiments of the stator 16 and the set of commutation modules 20.

The gear stage 14 which is connected downstream of the motor 12 steps down the rotation of the rotor 18 to a slower rotation of an output drive 30 of the drive unit 10. The gear stage 14 is preferably designed in a multistage manner from various gear types which are known per se, for example from an eccentric epicyclic gear (the basic principle of which is disclosed, for example, in DE 10 2006 023 535 A1, the disclosure content of said document in this respect being expressly included) and a planetary gear (as disclosed, for example, in DE 20 2006 014 817 U1, the disclosure content of said document in this respect being expressly included). Differential gears can also be used, as disclosed in DE 10 2004 019 471 A1, the disclosure content of said document in this respect being expressly included. The output drive 30 is coupled, for example, by means of a circular sliding gear (surface pressure gear), as disclosed in U.S. Pat. No. 4,228,698 A for example, or alternatively an Oldham coupling (double slider crank gear), as described in EP 0 450 324 B1 for example.

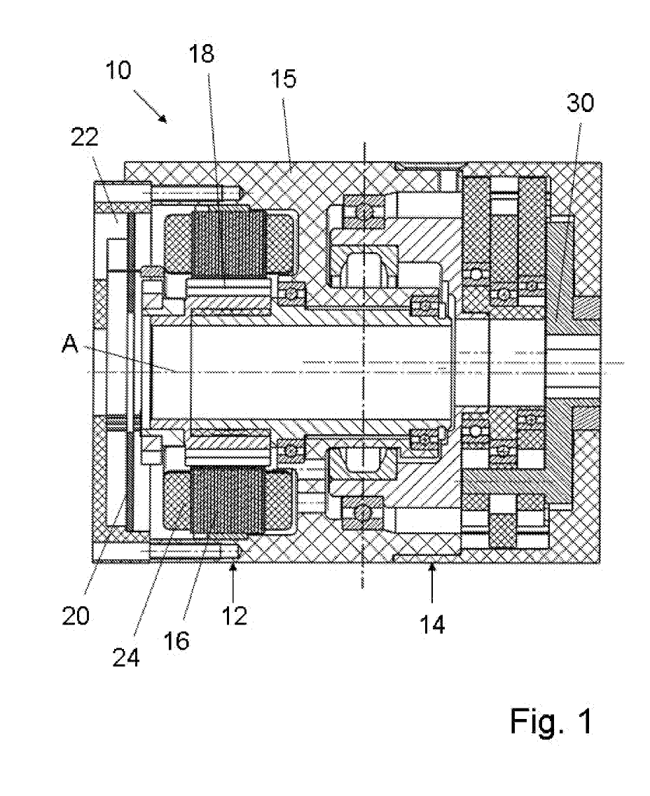

The drive unit 10 illustrated in FIG. 1 shows, within the housing 15, starting from the right-hand side, the output drive 30, the two-stage gear stage 14 and the parts of the brushlessly commutated motor 12, specifically the stationary stator 16 comprising individual coils 24, the roller-mounted rotor 18 which is fitted with individual permanent magnets, and the commutation module 20 which, in the variant illustrated here, comprises a printed circuit board with electronics components, comprises Hall sensors and comprises actuating magnets which are fixed to the rotor.

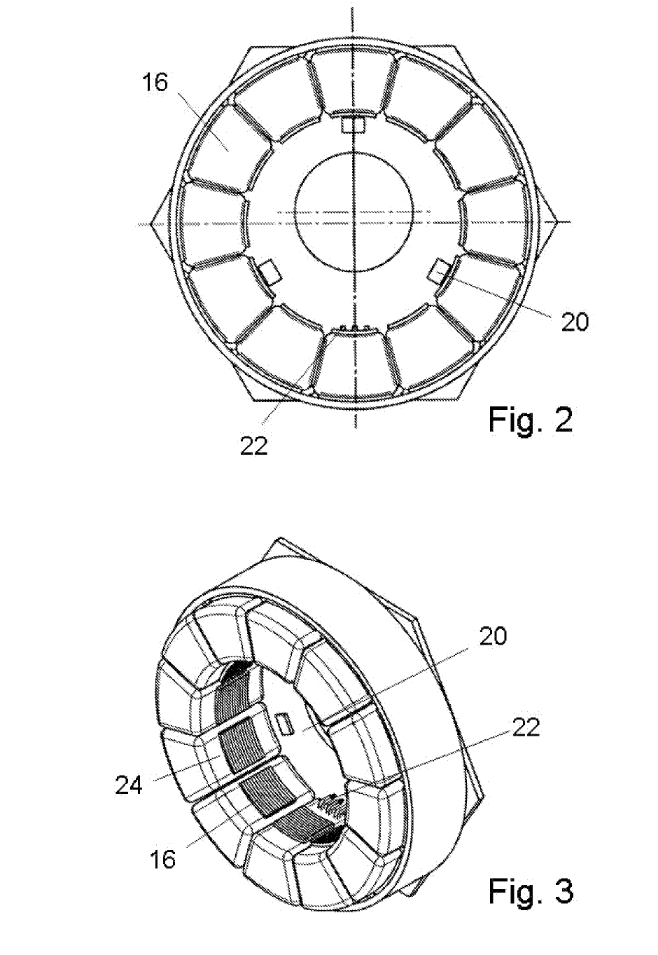

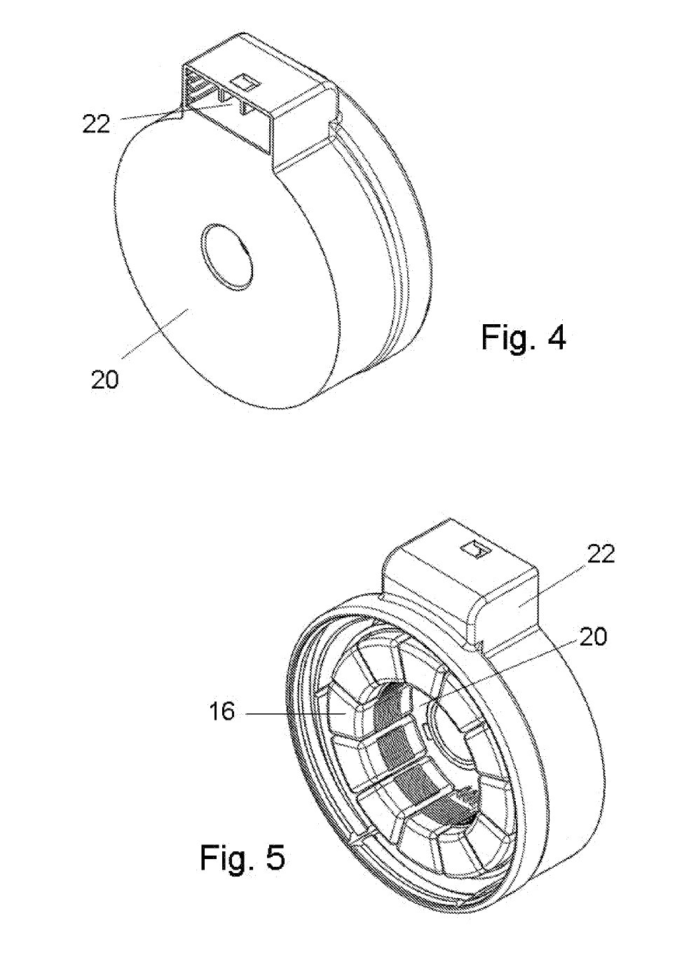

FIGS. 2 and 3 show further views of a unit comprising stator 16 and commutation module 20. FIG. 4 and FIG. 5 show a preferred embodiment in which stator 16, commutation module 20 and electrical connection 22 are combined to form a homogeneous exciter unit which can be exchanged for other variants.

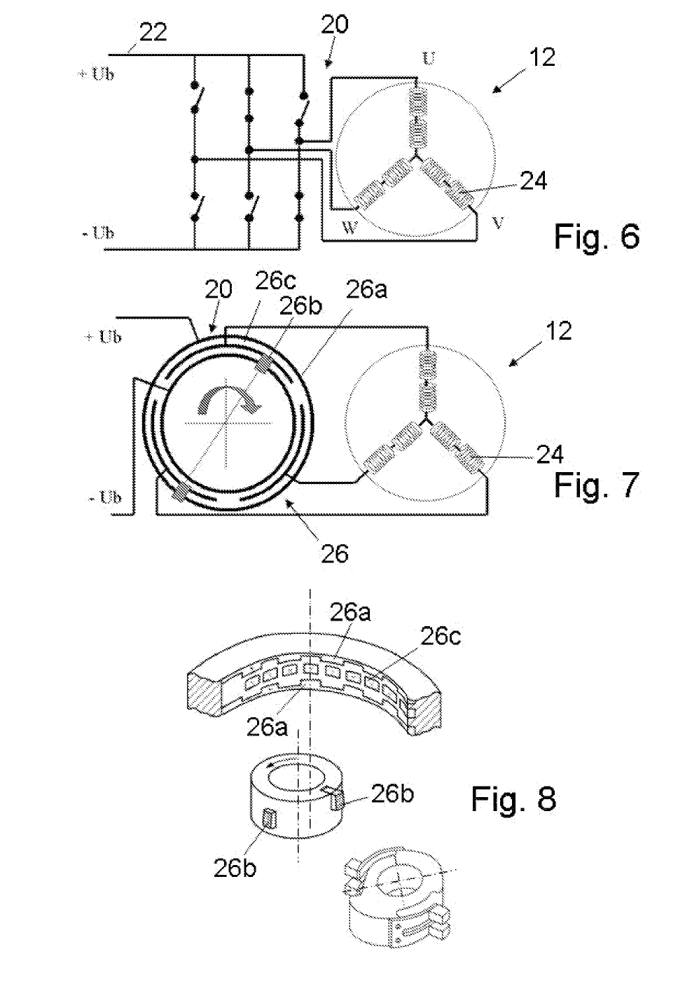

The basic manner of operation of the commutation, that is to say the successive connection of the ends of the coils 24 to the positive pole +Ub or to the negative pole −Ub of the supply voltage for the motor 12, is symbolically illustrated in FIG. 6. In the present case, the stator 16 is of bipolar and three-phase design, with each phase having at least one associated coil 24 (in the present case two individual coils which are connected in series). The coils 24 are connected to one another on one side and have in each case one of three connections U, V, W on the other side. The commutation module 20, by way of its sliding contacts 26 or other switches, connects the three connections U, V, W alternately to the positive pole +Ub or to the negative pole −Ub of the supply voltage, as a result of which in each case at least two coils 24 are supplied with current.

In the illustrated case, the connection W is connected to +Ub and the connection U is connected to −Ub, and therefore the current flows in the specifically required direction through the coils 24 connected between W and U. The illustrated circuit usually serves only to explain the operating principle since the required, short switching times cannot be realized with real microswitches, at least at appreciable rotation speeds. When this principle circuit is implemented for real, diverse semiconductor switching elements are therefore usually used today, these generally being actuated by upstream circuits which define the timing and the combination logic system. However, depending on the area of application and the intended use, the resulting further requirements made of the overall electronics system, such as polarity-reversal protection, interference suppression, overvoltage protection etc., lead to the proportion of total outlay on electronics fundamentally required for commutation being less than 40%. If, at the same time, the advantages of an intelligent fully electronic commutation (such as service life, regulation options, low noise level) are not necessarily required, the question of technical solutions which utilize the advantages of the mechanical design of this motor structure without being accompanied by the economic disadvantages arises.

The function of the switches illustrated in FIG. 6 is taken over by mechanical contact elements in the case of brush commutation, specifically by the sliding contacts 26 which can tolerate the required switching times and current loads. The mechanisms which are used today in classic, brush-commutated motors and comprise spring-loaded contact brushes and collectors which are produced from conductors and are connected to the rotor are entirely capable of this but, in terms of implementation, have to be matched to the other geometric conditions of a motor 12 with stationary coils 24. The basic function is clear from FIG. 7. The sliding contacts 26 are realized by concentric slip rings 26a which establish the respective contact to the supply voltage, and two brush elements 26b which extend over tracks and are fixed to the rotor, that is to say are fixedly connected to the rotor 18. FIG. 8 shows, in an exploded manner, the individual parts of the sliding contact 26, that is to say a holder with (along the axis A from top to bottom) a slip ring 26a which is connected to the positive pole +Ub, a series of slip ring segments 26c which are to be alternately connected to U, V, W, and a slip ring 26a which is connected to the negative pole −Ub. A brush holder which is fixed to the rotor is fitted with two brush elements 26b which, in the alternative embodiment at the bottom of FIG. 8, are in the form of individual brushes on leaf springs. The brush elements 26b are axially offset in such a way that each brush element 26b interacts with exactly two tracks, that is to say only with exactly one slip ring 26a and with the slip ring segments 26c. The stationary slip rings 26a and brush elements 26b which are fixed to the rotor are more advantageous than a commutation device with slip rings 26a which are fixed to the rotor, which commutation device is already known from DE 699 20 974 T2 in terms of the selection option between a plurality of commutation modules 20. A radial brush arrangement is described in DE 24 23 162 C2, but with mounted, rotating rollers instead of spring-loaded, radially guided brushes.

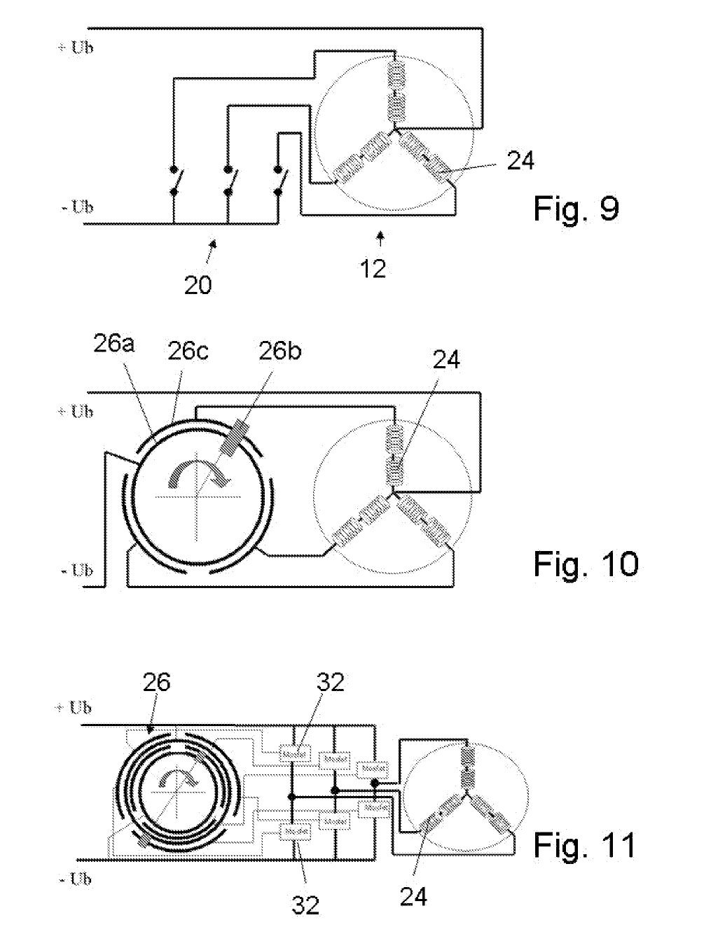

Consistent continuation of the reduction concept to the minimum required outlay leads to a unipolar variant of the motor 12 in which, in contrast to the embodiments of the motor 12 illustrated up to this point, all the coils 24 are connected, on one side, fixedly to one pole of the supply voltage, in the present case to the positive pole +Ub, and are switched on only in the correct order. FIG. 9 shows a basic circuit diagram, FIG. 10 shows a basic illustration with a slip ring 26a and three slip ring segments 26c which are to be connected to the three connections U, V, W (which are each associated with a coil 24).

As can be seen in FIG. 10, only one single brush element 26b is required for the simplest embodiment of a unipolar motor 12 of this kind, it being possible for said brush element to be geometrically realized in the same way as in FIG. 8. The fact that a motor 12 of this kind is less advantageous than the bipolar solutions in acoustic terms and in terms of its installation space/performance ratio is compensated for under specific boundary conditions by its low production costs. Since the embodiment of the stator 16 is identical, apart from the additional connection, the result of this variant is a commutation module 20 on a lower technical level, but which is to be considered an entirely expedient addition from an economical point of view.

The principal disadvantage of the above-described solutions of directly switching the currents through the coils 24 by means of brush elements 26b is the friction which is produced on account of the comparatively high, requisite contact pressure forces, and the associated development of noise and wear. However, this disadvantage can be remedied by brush-based generation of the required electrical connections being performed in the desired order and orientation but only at the lowest current level, and additionally downstream electronic switches 32, in particular semiconductor switching elements, being used for the high currents. FIG. 11 symbolically shows a solution of this kind in which the electronic switches 32 may be in the form of MOSFETs.

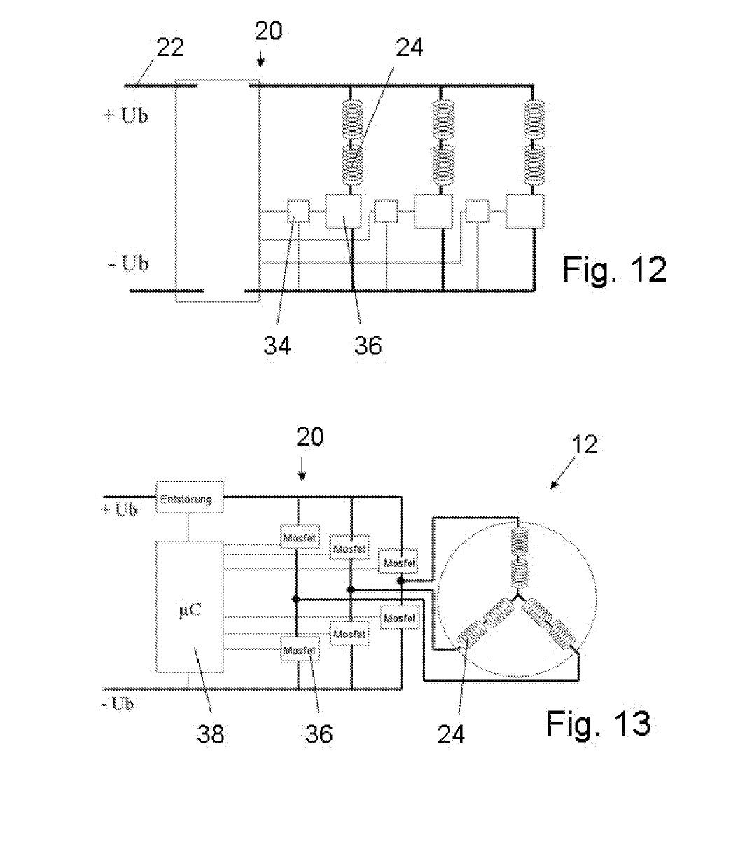

A further feasible and expedient development involves the transfer from the mechanical to the first, purely electronic, contact-free commutation which, in the simplest case, is made up of a plurality of units which are identical to one another. This circuit, which is illustrated in FIG. 12 by way of example for a unipolar motor 12, in the commutation module 20 comprises, in addition to a unit which conditions the supply voltage and the differentiation contained therein for the required direction of rotation, for example, three assemblies which are identical to one another and each comprise a sensor 34 (preferably a Hall sensor), a power semiconductor 36 as the electronic switch 32, and a coil 24.

The next further technical development is a brushless motor 12 which is commutated by microprocessor- or software-based control and regulation of the individual phase currents of the coils 24 by, in a classic manner, a triple half-bridge comprising power semiconductors 36 being used to generate a plurality of currents of different phase angle and amplitude through the coils 24. The power semiconductors 36 are actuated by a microprocessor 38 which checks the phase angle of the rotor 18, for example by means of sensors 34. FIG. 13 shows, roughly schematically, the essential functional elements of a control system of this kind which, in spite of a virtually identical design, permits a large number of commutation forms which differ in terms of detail and effect.

Starting from simple block commutation by means of trapezoidal, sinusoidal and sine-based signal forms with overmodulation up to field-oriented regulation, a large number of algorithms and methods which are known per se can be used which influence the rotation speed and/or the torque of a motor 12 of this kind in a deliberate manner. Control and regulation methods which are known per se, possibly taking into consideration further physical variables from the area surrounding the drive and possibly using bus-based information interchange between a plurality of intelligent units, can likewise match the drive exactly to what is respectively required for its use.

In virtually all cases of the use of such a motor 12, particular importance is placed on the phase angle between the electrically generated rotary field and the rotor magnetic field generated by the permanent magnets of the rotor 18, and for this reason diverse methods, from simple rotor position detection by means of Hall sensors by means of detecting the back-e.m.f. of the individual coils 24, to a co-running mathematical motor model based on a measurement of the total current, are used in drive technology for detection and/or control of said fields.

From the group comprising the selectable commutation modules 20, the circuit illustrated in FIG. 13, together with its described options for software control, represents the high-end module.

The four described commutation options
with brushes and directly, as in FIGS. 7 and 10,
with brushes and electronic switches, as in FIG. 11,
in a brushless manner with sensors and power semiconductors, as in FIG. 12, and
in a brushless manner with microprocessors and power semiconductors, as in FIG. 13, and the two embodiments of the stator
unipolar, as in FIGS. 10 and 12, and
bipolar, as in FIGS. 7, 11 and 13
   produce eight variants of the combination comprising stator 16 and commutation module 20. If this combination comprising stator 16 and commutation module 20 (and preferably electrical connection 22) forms the physically combined exciter unit, the exciter unit can be selected from a set of eight variants which each interact with the same rotor 18.

While specific embodiments of the invention have been described in detail to illustrate the application of the principles of the invention, it will be understood that the invention may be embodied otherwise without departing from such principles.

1. A drive unit for an adjuster in a vehicle the drive unit comprising:
a motor which has a stator with at least one coil, at least one rotor which is fitted with permanent magnets, rotates about an axis and magnetically interacts with the stator;
a commutation module for supplying current to the coil as a function of the rotation of the rotor; and
an electrical connection for an at least two-pole supply voltage, wherein the commutation module is selected from a set of brush-commutating and brushless commutation modules, with the motor otherwise being of the same design.

2. The drive unit as claimed in claim 1, wherein the stator and the commutation module and preferably the electrical connection are physically combined to form an exciter unit.

3. The drive unit as claimed in claim 1, wherein the stator is of unipolar or bipolar design.

4. The drive unit as claimed in the preamble of claim 1, wherein the commutation module connects the coils of the stator on one side alternately to one pole of the supply voltage by means of a single brush element as a function of the rotation of the rotor.

5. The drive unit as claimed in the preamble of claim 1, wherein the coils of the stator on at least one side are connected to one of the two poles of the supply voltage by means of in each case one electronic switch of the commutation module, and in that the commutation module alternately opens and closes its electronic switches as a function of the rotation of the rotor.

6. The drive unit as claimed in claim 1, wherein the commutation module has a microprocessor and/or sensors for controlling power semiconductors.

7. The drive unit as claimed in claim 1, wherein the commutation module has at least one sliding contact for supplying current to the coils.

8. The drive unit as claimed in claim 7, wherein the sliding contact has a stationary slip ring or slip ring segments and at least one brush element.

9. The drive unit as claimed in claim 8, wherein at least two slip rings or slip ring segments are arranged along the axis, with each slip ring having exactly one associated brush element.

10. The drive unit as claimed in claim 8, wherein each of the coils of the stator has a connection which is connected to exactly one of the slip ring segments and which can be connected to the slip ring by means of the brush element as a function of the rotation of the rotor.

11. The drive unit as claimed in claim 8, wherein the provided brush elements are seated on a brush holder which is fixedly connected to the rotor.

12. The drive unit as claimed in claim 1, wherein at least one gear stage is provided on the output side of the motor.

13. A vehicle seat adjuster drive unit comprising:
a motor with a stator with at least one coil, at least one rotor which is fitted with permanent magnets and rotates about an axis and magnetically interacts with the stator;
a commutation module for supplying current to the coil as a function of the rotation of the rotor the commutation module being one of a set of brush-commutating and brushless commutation modules;
a motor commutator module interface for physical and functional connection of the motor to the commutation module with any one of the set of brush-commutating and brushless commutation modules; and
an electrical connection for an at least two-pole supply voltage wherein.

14. The drive unit as claimed in claim 13, wherein the stator and the commutation module and the electrical connection are physically combined to form an exciter unit.

15. The drive unit as claimed in the preamble of claim 13, wherein the commutation module connects the coils of the stator on one side alternately to one pole of the supply voltage by means of a single brush element as a function of the rotation of the rotor.

16. The drive unit as claimed in the preamble of claim 13, wherein the coils of the stator on at least one side are connected to one of the two poles of the supply voltage by means of in each case one electronic switch of the commutation module, and in that the commutation module alternately opens and closes electronic switches of the commutation module as a function of the rotation of the rotor.

17. The drive unit as claimed in claim 13, wherein the commutation module has a microprocessor and/or sensors for controlling power semiconductors.

18. The drive unit as claimed in claim 13, wherein:
the commutation module has at least one sliding contact for supplying current to the coils; and
the sliding contact has a stationary slip ring or slip ring segments and at least one brush element.

19. The drive unit as claimed in claim 18, wherein each of the coils of the stator has a connection which is connected to exactly one of the slip ring segments and which can be connected to the slip ring by means of the brush element as a function of the rotation of the rotor.

20. The drive unit as claimed in claim 13, further comprising: at least one gear stage on the output side of the motor.
